(19) United States
(12) Patent Application Publication
(10) Pub. No.: US 2010/0299211 A1
(43) Pub. Date: Nov. 25, 2010

(54) Method, Apparatus And System For Determining Behavior Attribute Of User And Method And System For Delivering Advertisement

(75) Inventor: Shuang Wu, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen City (CN)

(21) Appl. No.: 12/848,367

(22) Filed: Aug. 2, 2010

Related U.S. Application Data
(63) Continuation of application No. PCT/CN2009/073000, filed on Jul. 30, 2009.

(30) Foreign Application Priority Data
Aug. 29, 2008 (CN) 200810119229.1

(51) Int. Cl. G06Q 30/00; G06F 17/30

(52) U.S. Cl. 705/14.66; 707/749; 707/E17.084

(57) ABSTRACT

A system and method for determining behavior attributes of a user and for delivering an advertisement. The behavior attributes of the user are determined by: obtaining, by the client, the transmission information of the user, matching the transmission information with preset matching words, determining the corresponding attributes of matching words which match the transmission information, obtaining the preset weights or accumulative weights of the corresponding attributes, reporting the user identity of the user, preset weights or accumulative weights, and attribute identities to the attribute server at the network side; respectively accumulating, by the attribute server, the reported preset weights or accumulative weights of the user according to the attribute identities, determining the attribute corresponding to the maximal weight as the behavior attribute of the user, or determining multiple attributes corresponding to weights with relatively large sums as the behavior attributes of the user.

### CROSS-REFERENCE TO RELATED APPLICATIONS

This application is a continuation of International Application No. PCT/CN2009/073000, filed Jul. 30, 2009. This application claims the benefit and priority of Chinese Application No. 200810119229.1, filed Aug. 29, 2008. This application is a National Stage of The entire disclosures of each of the above applications are incorporated herein by reference.

### FIELD

The present disclosure relates to to a Network communication field, and more particularly to a method, apparatus, and system for determining behavior attributes of a user according to transmission information of the user in the communication process, and to a method and system for delivering advertisements according to the behavior attributes of the user.

### BACKGROUND

This section provides background information related to the present disclosure which is not necessarily prior art.

In the prior art, the network communication is convenient and quick, and various communication modes have arisen. For instance, users log on the network and send information to each other through E-mails, or log on the network and perform online chatting through IM tools, etc.

At present, for a user participating in the network communication, the conventional method is usually restricted to obtain and record some natural attribute information (i.e. static information), such as the name (including net name or nickname), sex and age of the user. The natural attribute information can not characterize the behavior attributes of the user, such as interests, hobbies and specialities, resulting in that the network operator can not provide corresponding characteristic services for the user according to personalized behavior attributes thereof, for instance can not deliver to the user corresponding advertisement information meeting the interests and hobbies of the user.

In the present network, partial advanced technologies can perform keyword matching according to contents of the user's current session, and deliver relevant advertisement information to the user according to the current successfully-matched keyword. However, there is a big error in the simple instant matching, such as if the session information currently input by the user is going to Yangshuo by car tomorrow. The keyword that may be matched is the car. Thus, it may begin to deliver a car advertisement to the user. However, the user may not be interested in the car advertisement at all.

Thus, in order to further enhance the performance of the service provided to the user by the network and satisfaction of the user, for different users, it needs to accurately determine the behavior attributes of the users. However, in the prior art, there is no a mature technology, which can accurately position the behavior attributes of the users, and provide the users with corresponding characteristic services according to the behavior attributes of the users.

### SUMMARY

This section provides a general summary of the disclosure, and is not a comprehensive disclosure of its full scope or all of its features.

Embodiments of the present invention provide a method and system for determining the behavior attributes of the user, which can accurately determine the behavior attributes of the user by analyzing a large amount of information sent from the user, and further provide a method and system for delivering advertisements according to the behavior attributes of the user.

An embodiment of the present invention provides a method for determining behavior attributes of a user, including:

obtaining, by a client, transmission information from a user, matching the transmission information with preset matching words, and determining corresponding attributes of matching words which match the transmission information;

obtaining, by the client, a preset weight of each attribute in the corresponding attributes, and reporting a user identity of the user, the preset weights, and attribute identities of the corresponding attributes to an attribute server at the network side; or

accumulating, by the client, the preset weight of each attribute in the corresponding attributes, obtaining accumulative weights, and reporting the user identity of the user, the accumulative weights and the attribute identities of the corresponding attributes to the attribute server at the network side, and configuring the accumulative weights reported this time as zero after completing the reporting; and

respectively accumulating, by the attribute server, the reported preset weights or accumulative weights of the user corresponding to the user identity according to the attribute identities, obtaining a sum of each attribute corresponding to the user, determining an attribute corresponding to the maximal sum as the behavior attribute of the user and storing the behavior attribute, or determining attributes corresponding to preset number of sums which are selected in a descending order as behavior attributes of the user and storing the behavior attributes.

Another embodiment of the present invention provides a system for determining behavior attributes of a user, including: a client and an attribute server.

The client is configured to obtain transmission information of a user, match the transmission information with preset matching words, determine corresponding attributes of matching words which match the transmission information, obtain a preset weight of each attribute in the corresponding attributes, report a user identity of the user, the preset weights, and attribute identities of the corresponding attributes to the attribute server at the network side; or respectively accumulate the preset weight of each attribute in the corresponding attributes, obtain accumulative weights, and report the user identity of the user, the accumulative weights and the attribute identities of the corresponding attributes to the attribute server, and configure the accumulative weights reported this time as zero after completing the reporting; and

the attribute server is configured to respectively accumulate the reported preset weights or accumulative weights of the user corresponding to the user identity according to the attribute identities, obtain a sum of each attribute corresponding to the user, determine an attribute corresponding to the maximal sum as a behavior attribute of the user and store the behavior attribute; or determine attributes corresponding to preset number of sums which are selected in a descending order as behavior attributes of the user and store the behavior attributes.

Another embodiment of the present invention provides a method for delivering an advertisement, including:

receiving an advertisement playing request which is initiated by a client and carries a user identity;

obtaining behavior attribute information of a corresponding user according to the user identity from an attribute server at the network side;

matching advertisements with the behavior attribute information of the user, and sending a corresponding advertisement which matches the behavior attribute information to the client; wherein

the behavior attribute of the user is determined by:

obtaining, by a client, transmission information from the user, matching the transmission information with preset matching words, and determining corresponding attributes of matching words which match the transmission information;

obtaining, by the client, a preset weight of each attribute in the corresponding attributes, and reporting a user identity of the user, the preset weights, and attribute identities of the corresponding attributes to the attribute server at the network side; or

accumulating, by the client, the preset weight of each attribute in the corresponding attributes, obtaining accumulative weights, and reporting the user identity of the user, the accumulative weights and the attribute identities of the corresponding attributes to the attribute server at the network side, and configuring the accumulative weights which are reported this time and stored in local as zero after completing the reporting; and

respectively accumulating, by the attribute server, the reported preset weights or accumulative weights of the user corresponding to the user identity according to the attribute identities, obtaining a sum of each attribute corresponding to the user, determining an attribute corresponding to the maximal sum as the behavior attribute of the user and storing the behavior attribute, or determining attributes corresponding to preset number of sums which are selected in a descending order as behavior attributes and storing the behavior attributes.

Another embodiment of the present invention provides a system for delivering an advertisement, including a client, an attribute server and an advertisement server.

The client is configured to obtain transmission information of a user, match the transmission information with preset matching words, determine corresponding attributes of matching words which match the transmission information, obtain a preset weight of each attribute in the corresponding attributes, report a user identity of the user, the preset weights, and attribute identities of the corresponding attributes to the attribute server at the network side; or respectively accumulate the preset weight of each attribute in the corresponding attributes, obtain accumulative weights, report the user identity, the accumulative weights and the attribute identities of the corresponding attributes to the attribute server and configure the accumulative weights which are saved in local and reported this time as zero after completing the reporting; initiate an advertisement playing request carrying the user identity to the advertisement server, receive an advertisement delivered by the advertisement server and playing the advertisement;

the attribute server is configured to respectively accumulate reported preset weights or accumulative weights of the user corresponding to the user identity according to the attribute identities, obtain a sum of each attribute corresponding to the user, determining an attribute corresponding to the maximal sum as a behavior attribute of the user and store the behavior attribute, or determine attributes corresponding to preset number of sums which are selected in a descending order as behavior attributes of the user and store the behavior attributes, receive a user attribute query request sent from the advertisement server, and return the behavior attribute information of the corresponding user which is stored in local to the advertisement server; and

the advertisement server is configured to receive the advertisement playing request sent from the client, send the user attribute query request carrying the user identity to the attribute server according to the user identity carried in the advertisement playing request, receive the behavior attribute information of the corresponding user returned by the attribute server, match advertisements with the behavior attribute information of the user and deliver an advertisement which matches the behavior attribute information to the client.

Embodiments of the present invention can bring the following technical effects:

In the embodiments of the present invention, the matching words, corresponding attributes of each matching word, and the preset weight of each attribute are preset, and the client obtains the transmission information of the user, matches the transmission information with the preset matching words, determines the corresponding attributes of the matching words which match the transmission information, respectively accumulates the preset weight of each attribute in the corresponding attributes, stores the accumulative weights after finishing the accumulation, reports the user identity of the user, accumulative weights stored in local, i.e. in the client, and attribute identities of the corresponding attributes to the attribute server at the network side through the network. The attribute server at the network side determines the corresponding user according to the user identity, respectively accumulates reported accumulative weights of the user according to the attribute identities, determines the attribute corresponding to the maximal sum of weights as the behavior attribute of the user, or determine multiple attributes corresponding to sums with relatively large values as the behavior attributes of the user. Since the client processes the information sent from the user each time and adopts an accumulation mode, the probability that the weights of the corresponding attributes of the matching words with a relatively high emergence frequency in the huge amount information sent from the user are accumulated increases, and thus the accumulative weights of the corresponding attributes increase. It is accurate to select the corresponding attributes of the maximal accumulative weight as the behavior attributes of the user. Since the matching word with a relatively high emergence frequency relates to things that interest the user most, the corresponding attributes (one or a plurality of attributes) of the matching word is closely related to one or a plurality of behavior attributes of the user, and the preset weights of the attributes represent the value of the relevance, it is accurate to determine the behavior attributes of the user according to the accumulative weights of the attributes.

According to the determined and accurate behavior attributes of the user, the advertisement is delivered to the user or characteristic services are provided to the user, which makes the pertinence of the advertisement more strong and effectively enhances the satisfaction of the user and the QoS of the network operator.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart illustrating a method for determining behavior attributes of a user according to an embodiment of the present invention;

FIG. 2 is a first block diagram illustrating structure of a client according to an embodiment of the present invention;

FIG. 3 is a second block diagram illustrating structure of a client according to an embodiment of the present invention;

FIG. 4 is a first block diagram illustrating structure of an attribute server according to an embodiment of the present invention;

FIG. 5 is a second block diagram illustrating structure of an attribute server according to an embodiment of the present invention;

FIG. 6 is a block diagram illustrating structure of a system for determining behavior attributes of a user according to an embodiment of the present invention;

FIG. 7 is a flow chart illustrating a method for delivering advertisements according to an embodiment of the present invention; and

FIG. 8 is a block diagram illustrating structure of a system for delivering advertisements according to an embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

Embodiments of the present invention provide a method, apparatus and system for determining the behavior attributes of the user. The behavior attributes of the user can be accurately determined according to a large amount of information sent from the user, and the advertisements can be delivered according to the behavior attributes of the user. Thus, the advertisements can be played pertinently and effectively.

The method, apparatus and system provided by embodiments of the present invention are described in detail hereinafter with reference to accompanying drawings.

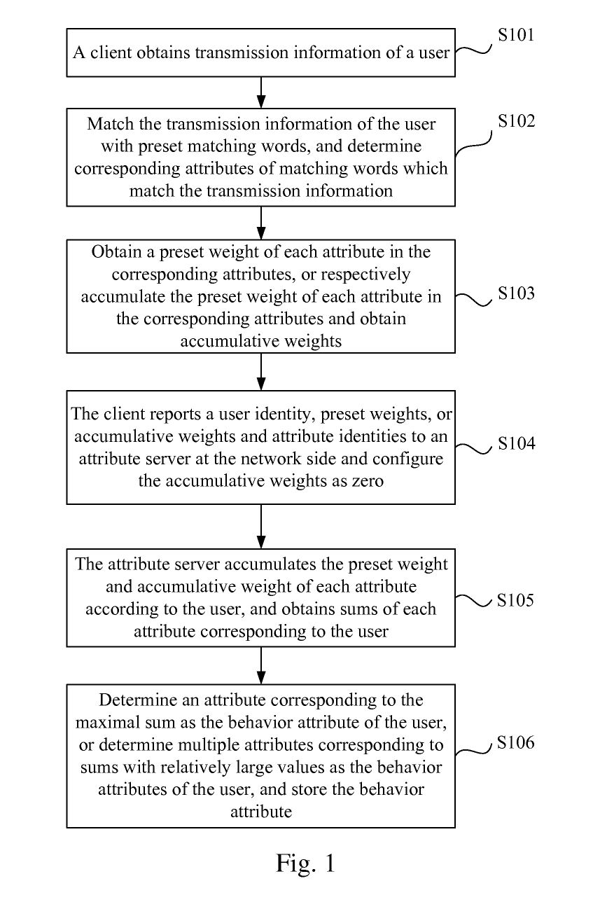

Refer to FIG. 1, FIG. 1 is a flow chart illustrating a method for determining the behavior attributes of the user according to an embodiment of the present invention. The method includes the following blocks.

Block S101: A client obtains transmission information of a user.

Block S102: The matching between the transmission information of the user and preset matching words is performed, and corresponding attributes of matching words which match the transmission information are determined.

Block S103: A preset weight of each attribute of the determined corresponding attributes is determined; or the preset weight of each attribute of the corresponding attributes is respectively accumulated to obtain an accumulative weight.

Block S104: The client reports a user identity, the preset weights and attributes identities of the corresponding attributes to an attribute server at the network side; or reports the user identity, accumulative weights and attributes identities of the corresponding attributes to the attribute server at the network side, and sets the accumulative weight which is saved in local and reported this time as zero after finishing the reporting.

Block S105: The attribute server determines the corresponding user according to the user identity, respectively accumulates the preset weights or the accumulative weights which are reported and correspond to the user according to the attribute identities, to obtain the sum of each attribute corresponding to the user.

Block S106: The attribute corresponding to the maximal sum is determined as the behavior attribute of the user and is saved; or the attributes corresponding to preset number of sums which are selected in a descending order are determined as the behavior attributes of the user and saved.

The blocks illustrated in FIG. 1 are described in detail hereinafter.

In block S101, the transmission information of the user may be the transmission information of various communication modes. For instance, when the user logs on the Internet and uses an E-mail transmitting system, the transmission information includes the body, subject and content information of an attachment, etc. of an E-mail sent from the user.

For another instance, when the user logs on the Internet and chats with the IM, the transmission information of the user is the information input by the user in a chatting window.

In block S102, the matching words, attributes identities corresponding to the matching words and preset weights of the attributes are saved in a client in advance. The specific saving modes are not limited. For instance, the attribute server at the network side sends the locally saved matching words, the attributes identities corresponding to the matching words and the preset weights of the attributes to the client, and the client receives and saves the information received from the attribute server. Certainly, if the matching words, the attributes identities corresponding to the matching words and the preset weights of the attributes saved in the attribute server are updated, the attribute server sends the updated matching words, the attributes identities corresponding to the matching words and the preset weights of the attributes to the client for corresponding updating.

Each matching word may correspond to one or more attributes, each attribute has an attribute identity, and each attribute has a preset weight.

Each attribute may correspond to one or more matching words, and each attribute may have different preset weights when corresponding to different matching words.

A preset weight is a numerical value, which may be a positive number or negative number. The positive number indicates that the attribute is possessed. The larger the value, the larger the possibility of that the attribute is possessed. The negative number indicates that the attribute is not possessed. The smaller the value, the smaller the possibility of that the attribute is possessed.

Table one below is an example including preset matching words, attributes identities (the attribute identities may be expressed in many modes, take the value for example in the table bellow) corresponding to the matching words, and preset weights of the attributes.

TABLE ONE

| Matching word | Attribute identity | Preset weight |
|---|---|---|
| fund | 2 (represent caring for economic) | 10 |
| fund | 3 (represent caring for stock) | 50 |
| image | 1 (represent relating to Computer) | 20 |
| image | 4 (represent caring for multi-media) | 40 |
| mountaineering | 5 (represent being fond of sports) | 50 |
| mountaineering | 5 (represent being fond of sports) | 30 |
| mountaineering | 7 (represent pregnant women) | −100 |

The above table one is only a simple example. In practice, several matching words may be set, and the matching words may be added or deleted. The attributes corresponding to the matching words may also be added or deleted, or the preset weights of the attributes may be modified.

For brief description, it is supposed that the matching words, the attribute identities corresponding to the matching words, and preset weights of the attributes are those shown in table one. In block S102, a matching between the obtained transmission information of the user and the matching words in table one is performed. It is supposed matching words which match the transmission information are “fund” and “image”. It is determined that the attributes corresponding to the successfully-matched matching words are attribute 2, attribute 3, attribute 1 and attribute 4.

In Block S103, this block may be implemented in two modes, which are respectively described as follows.

Implementation mode one: The preset weights of the attributes determined in block S102 are determined. Follow the above example, the preset weight 10 of attribute 2, preset weight 50 of attribute 3, preset weight 20 of attribute 1 and preset weight 40 of attribute are obtained.

Implementation mode two: The preset weights of the attributes determined in block S102 are accumulated. Follow the above example, it is supposed that the client saves the last accumulative weights of the user. The accumulative weight of attribute 2 is 20, thus the accumulative result of this time is: 20 (the last accumulative weight of attribute 2) plus 10 (the preset weight of attribute 2) is 30. This is to say, the accumulative weight of attribute 2 is 30.

Similarly, it is supposed that the accumulative weight of attribute 3 of the user saved by the client is 50. The accumulative result of this time is: 50 (the last accumulative weight of attribute 3) plus 50 (the preset weight of attribute 3) is 100. This is to say, the accumulative weight of attribute 3 is 100.

It is supposed that the matching word “image” is successfully matched for the first time, the accumulative weight of attribute 1 is the preset weight 20 (the previous accumulative weight is zero) of attribute 1. Similarly, the accumulative weight of attribute 4 is the preset weight 40 of attribute 4.

In block S104, as for the two kinds of implementation modes adopted by block S103, the corresponding processing methods of block S104 are as follows:

Processing method one: The user identity of the user, the preset weights and attribute identities of corresponding attributes are reported to the attribute server at the network side. Follow the above example, the information that is required to report to the attribute server at the network side includes:

the user identity, (attribute 2, preset weight 10), (attribute 3, preset weight 50), (attribute 1, preset weight 20) and (attribute 4, preset weight 40).

In the above processing method one, substantially, the client reports each matching result to the attribute server at the network side, and the attribute server performs all the accumulation processing.

Processing method two: The user identity of the user, the accumulative weights and attribute identities of the corresponding attributes are reported to the attribute server at the network side. The accumulative weights that are locally saved and reported this time are set as zero. Follow the above example, the information that is required to report to the attribute server at the network side includes:

the user identity, (attribute 2, accumulative weight 30), (attribute 3, accumulative weight 100), (attribute 1, accumulative weight 20) and (attribute 4, accumulative weight 40).

In an embodiment, in order to avoid reporting too much information to the attribute server when too many attributes are matched successfully, a reporting threshold may be set. The current accumulative weight of each attribute is compared with the set threshold, only the accumulative weight and attribute identity thereof, in which the current accumulative weight is larger than the set threshold, are reported to the attribute server at the network side.

As for those accumulative weights that have been reported to the attribute server at the network side, the attribute server saves these accumulative weights and adds up the accumulative weights of a same user. In order to avoid the repeated reporting of the accumulative weights and error of the accumulating result, the client needs to set the accumulative weights that are locally saved and reported this time as zero, so that the weights of the corresponding attributes can be accumulated by the client from zero next time.

Block S104: As for the situation that the client reports the accumulative weights, there may be a plurality of triggering conditions of the reporting. The present invention does not make limitation on the triggering conditions. For instance, the accumulative weights may be periodically reported, or be reported when one or multiple accumulative weighs, each of which is larger than a preset threshold.

Block S105: The attribute server determines a corresponding user according to a user identity, and respectively accumulates preset weights or accumulative weights reported and corresponding to the user according to the attribute identities to obtain the sum of each attribute corresponding to the user. Follow the above example, the reported information received by this attribute server includes the user identity, (attribute 2, accumulative weight 30), (attribute 3, accumulative weight 100), (attribute 1, accumulative weight 20), and (attribute 4, accumulative weight 40).

It is supposed that the result of the user which is locally stored and obtained by the last accumulation includes: (attribute 2, accumulative sum 30), (attribute 3, accumulative sum 150), (attribute 1, accumulative sum 0) and (attribute 4, accumulative sum 0).

The result obtained by this accumulation includes:

attribute 2, accumulative sum 60;

attribute 3, accumulative sum 250;

attribute 1, accumulative sum 20; and

attribute 4, accumulative sum 40.

In block S106, the attribute corresponding to the maximal sum is determined as the behavior attribute of the user and saved, or the sums are sorted in a descending order and attributes corresponding to preset number of sums selected are determined as the behavior attributes and saved.

Follow the above example, if the attribute corresponding to the maximal sum is determined as the behavior attribute of the user, the behavior attribute of the user is attribute 3, that is to say, the user is caring for the stock.

If the attributes corresponding to three relatively large sums are determined as the behavior attributes of the user, the behavior attributes of the user include attribute 3, attribute 2 and attribute 4. That is to say, the user is caring for the stock, economic and multi-media.

The attribute server may be a public server set at the network side, may receive data reported by multiple clients, and may identify and manage the users according to the identities thereof. That is to say, the attribute server stores and dynamically updates the attribute identities corresponding to several users and corresponding weights obtained after the accumulation, determines the attribute corresponding to the maximal weight as the behavior attribute and saves the behavior attribute in local, or sorts the sums in a descending order and determines attributes corresponding to preset number of sums with relatively large values as the behavior attributes of the user and saves the behavior attributes in local, which provides relatively accurate behavior attribute information of the user when the behavior attribute of the user needs to be obtained by other network applications.

The flow of FIG. 1 is kept executed repeatedly. That is to say, the weight of each attribute relating to the user may be dynamically updated, and the attributes with relatively large weights are determined as the behavior attributes of the user through continuously obtaining the transmission information of the user and performing the analysis and accumulation according to the flow illustrated in FIG. 1. Thus, the objective of accurately determining the behavior attributes of the user is achieved through processing huge amount of information sent from the user.

Furthermore, according to the above method provided by the embodiment of the present invention, if the mode of reporting all the client data is adopted, the client only saves the attributes identities and accumulated accumulative weights obtained by the matching performed after the last reporting and before this reporting. However, the actual behavior attributes of the user can not be determined with the information and the private data of the user is not revealed.

If the reporting mode of preset threshold is adopted, what the client saves are the corresponding attribute identities and accumulative weights which do not exceed the preset threshold when being reported last time, and the attribute identities and accumulated accumulative weights obtained by the matching performed after the last reporting and before this reporting. However, the actual behavior attributes of the user can not be determined with the information and the private data of the user is not revealed.

In order to reduce the amount of information stored in the client, the client may periodically delete the history records of the user saved in local. That is to say, the client may delete the accumulative weights and attributes identities thereof which are not updated in a preset time period (for instance, one month).

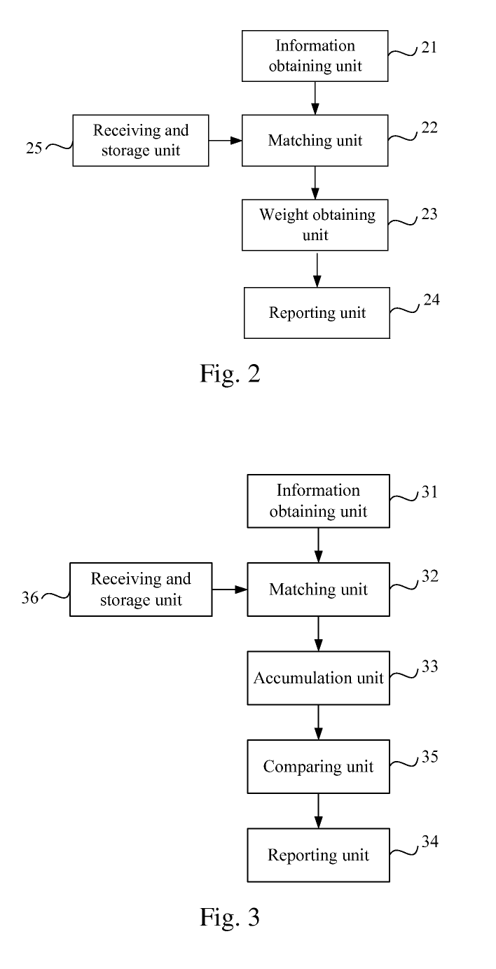

According to the implementation scheme that the attribute server at the network side performs all the accumulation processing in the method for determining the behavior attributes of the user provided by the above embodiments of the present invention, an embodiment of the present invention provides a client for implementing the corresponding function. The schematic diagram of the structure of the client is illustrated in FIG. 2. The client includes the following units.

An information obtaining unit 21 is configured to obtain transmission information of a user.

A matching unit 22 is configured to match the transmission information obtained by the information obtaining unit 21 with preset matching words, and determine corresponding attributes of matching words which match the transmission information.

A weight obtaining unit 23 is configured to obtain a preset weight of each attribute in the corresponding attributes.

A reporting unit 24 is configured to report a user identity of the user, the preset weights and attributes identities of the corresponding attributes to an attribute server at the network side.

In one embodiment, the client further includes the following units.

A receiving and storage unit 25 is configured to receive and store the matching words, corresponding attribute identities of the matching words and the preset weight of each attribute issued by the attribute server at the network side.

A matching unit 22 is configured to perform matching according to the matching words stored by the receiving and storage unit 25, and determine corresponding attributes of the matching words which match the transmission information.

According to the implementation scheme that the client reports the accumulative weights in the method for determining the behavior attributes of the user provided by the above embodiments of the present invention, an embodiment of the present invention provides a client for implementing the corresponding function. The schematic diagram of the structure of the client is illustrated in FIG. 3. The client includes the following units.

An information obtaining unit 31 is configured to obtaining transmission information of a user.

A matching unit 32 is configured to match the transmission information obtained by the information obtaining unit 31 with preset matching words, and determine corresponding attributes of matching words which match the transmission information.

An accumulation unit 33 is configured to respectively accumulate the preset weight of each attribute in the corresponding attributes determined by the matching unit 32 and store accumulative weights obtained by the accumulation.

A reporting unit 34 is configured to report the user identity of the user, the accumulative weights stored in the accumulation unit 33 and attribute identities of the corresponding attributes to the attribute server at the network side, and set the accumulative weights reported this time as zero after the reporting.

In an embodiment, the client further includes:

a comparison unit 35, configured to obtain current accumulative weight of each attribute from the accumulation unit 33, compare the accumulative weight with the preset threshold, and report accumulative weights, each of which is larger than the preset threshold and attribute identities thereof to the reporting unit 34.

The reporting unit 34 sends the user identity of the user, and the accumulative weights transmitted from the comparison unit 35 and the attribute identities thereof to the attribute server at the network side.

In an embodiment, the client further includes:

a receiving and storage unit 36, configured to receive and store the matching words, the corresponding attribute identities of the matching words, and the preset weight of each attribute issued by the attribute server.

The matching unit 32 is configured to perform the matching according to the matching words stored in the receiving and storage unit 36, and determine the corresponding attributes of the matching words which match the transmission information.

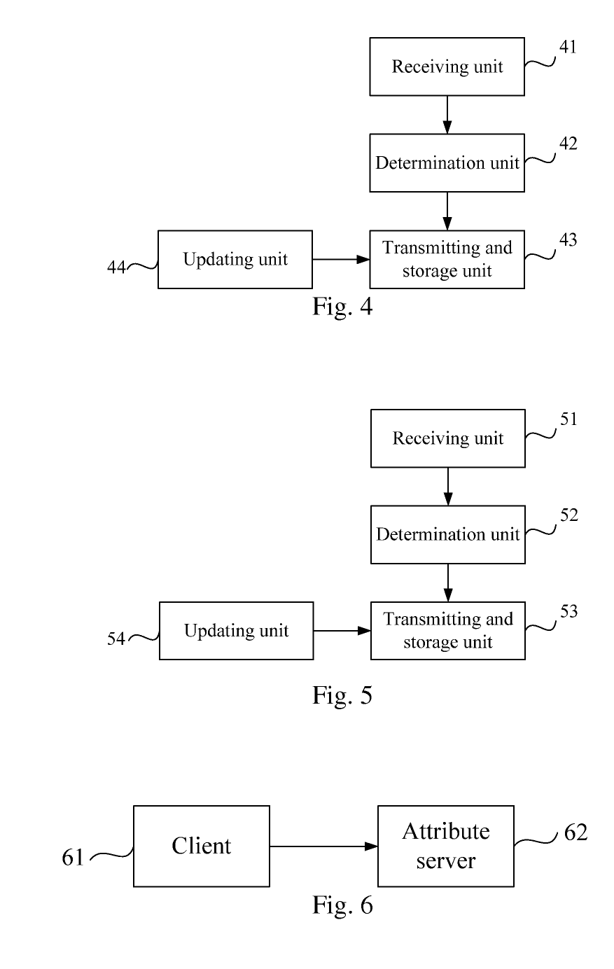

According to the implementation scheme that the attribute server at the network side performs all the accumulation processing in a method for determining the behavior attributes of the user provided by the above embodiment of the present invention, an attribute server for implementing the corresponding function is provided by an embodiment of the present invention. The schematic diagram of the structure of the attribute server is illustrated in FIG. 4. The attribute server includes the following units.

A receiving unit 41 is configured to receive a user identity, a preset weight of each attribute and attribute identities of corresponding attributes reported by a client.

A determination unit 42 is configured to accumulate the reported preset weights of the user corresponding to the user identity according to the attribute identities to obtain the sum of each attribute corresponding to the user, determine the attribute corresponding to the maximal sum as the behavior attribute of the user and save the behavior attribute, or sort the sums in a descending order and determine the attributes corresponding to preset number of sums selected as the behavior attributes of the user.

A transmitting and storage unit 43 is configured to store determined behavior attribute information of the user.

In an embodiment, the attribute server is further configured to store information, such as the matching words, the corresponding attribute identities of the matching words and the preset weight of each attribute in the transmitting and storage unit 43, which sends the information to the client.

In an embodiment, the attribute server further includes:

an updating unit 44, configured to update the information, such as the matching words, the corresponding attribute identities of the matching words, and the preset weight of each attribute stored in the transmitting and storage unit 43.

The transmitting and storage unit 43 is further configured to send the updated matching words, the corresponding attribute identities of the matching words and the preset weight of each attribute to the client.

According to the implementation scheme that the client reports the accumulative weights in the method for determining the behavior attributes of the user provided by the above embodiment of the present invention, an attribute server for implementing the corresponding function is provided by an embodiment of the present invention. The schematic diagram of the structure of the attribute server is illustrated in FIG. 5, the attribute server includes the following units.

A receiving unit 51 is configured to receive a user identity, an accumulative weight of each attribute and attribute identities of attributes reported by a client.

A determination unit 52 is configured to accumulate reported accumulative weights of the user corresponding to the user identity according to the attribute identities to obtain the sum of each attribute corresponding to the user, determine the attribute corresponding to the maximal sum as the behavior attribute of the user, or determine multiple attributes corresponding to sums with relatively large values as the behavior attributes of the user.

A transmitting and storage unit 53 is configured to store determined behavior attribute information of the user.

The method for obtaining the accumulative weight of each attribute is described hereinbefore, which includes:

The client obtains the transmission information of the user, matches the transmission information with preset matching words, determines the corresponding attributes of the matching words which match the transmission information, accumulates the preset weight of each attribute in the corresponding attributes and stores the accumulative weights obtained by the accumulation.

In an embodiment, the attribute server is further configured to store information such as, the matching words, the corresponding attribute identities of the matching words, and the preset weight of each attribute in the transmitting and storage unit 53. The transmitting and storage unit 53 sends the information to the client.

In an embodiment, the attribute server further includes:

an updating unit 54, configured to update the information such as the matching words, the corresponding attribute identities of the matching words and the preset weight of each attribute stored in the transmitting and storage unit 53. The transmitting and storage unit 33 is further configured to send the updated matching words, the corresponding attribute identities of the matching words, and the preset weight of each attribute to the client.

According to the client and attribute server provided by the above embodiments of the present invention, a system, capable of implementing the corresponding function, for determining the behavior attributes of the user is further provided by an embodiment of the present invention. The schematic diagram of the system is illustrated in FIG. 6. The system includes a client 61 and an attribute server 62.

The client 61 is configured to obtain transmission information of the user, match the transmission information with preset matching words, determine corresponding attributes of matching words which match the transmission information, obtain a preset weight of each attribute in the corresponding attributes, or further respectively accumulate the preset weight of each attribute in the corresponding attributes to obtain the accumulative weights; report the user identity of the user, the preset weights and the attribute identities of the corresponding attributes to the attribute server 62, or report the user identity of the user, the accumulative weights and the attribute identities of the corresponding attributes to the attribute server 62, and set the accumulative weights that are saved in local and reported this time as zero.

The attribute server 62 is configured to accumulate the reported preset weights or accumulative weights of the user corresponding to the user identity according to the attribute identities, determine the attribute corresponding to the weight of the maximal sum as the behavior attribute of the user and store the behavior attribute of the user, or determine attributes corresponding to preset number of sums which are selected in a descending order as the behavior attributes of the user.

In an embodiment, the client 61 is further configured to compare the current accumulative weight of each attribute which is saved in local with a preset threshold, and report the user identity, the accumulative weights each of which is larger than the preset threshold and attribute identities thereof to the attribute server at the network side.

In an embodiment, the attribute server 62 is further configured to store the matching words, corresponding attribute identities of the matching words and the preset weight of each attribute, and issue them to the client 61.

The client 61 is further configured to receive the matching words, the corresponding attribute identities of the matching words and the preset weight of each attribute issued by the attribute server 62 and save them in local.

Through the above method, apparatus and system, the behavior attribute information of the user is obtained and saved in the attribute server at the network side. When other applications in the network need to obtain the behavior attribute information of the user, these applications may obtain the behavior attribute information of the user through querying the attribute server.

A method and system for delivering an advertisement is described hereinafter in detail taking playing corresponding advertisement to the user according to the behavior attribute of the user for an example.

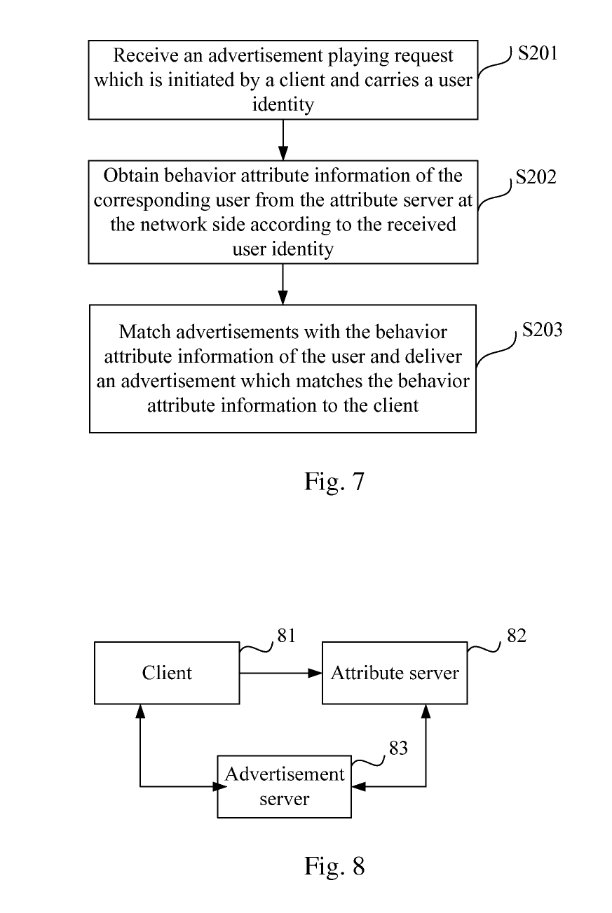

Refer to FIG. 7, FIG. 7 is a flow chart illustrating a method for delivering an advertisement according to an embodiment of the present invention. The method includes:

Block S201: Receive an advertisement playing request which is initiated by a client and carries a user identity.

Block S202: Obtain behavior attribute information of the corresponding user from the attribute server at the network side according to the received user identity.

Block S203: Find a corresponding advertisement by matching according to the behavior attribute information of the user and deliver the advertisement to the client.

The behavior attribute of the user is determined by the client and the attribute server at the network side adopting the flow illustrated in the above FIG. 1. The specific determination method is not described repeatedly.

According to the above method for delivering an advertisement, the schematic diagram illustrating a corresponding system for delivering an advertisement is shown in FIG. 8. The system includes a client 81, an attribute server 82 and an advertisement server 83.

The client 81 is configured to obtain the transmission information of the user, match the transmission information with preset matching words, determine corresponding attributes of matching words which match the transmission information, obtain the preset weight of each attribute in the corresponding attributes. The client is further configured to respectively accumulate the preset weight of each attribute in the corresponding attributes to obtain the accumulative weights, and report the user identity of the user, the preset weights and attribute identities of the corresponding attributes to the attribute server at the network side, or report the user identity of the user, the accumulative weights and the attribute identities of the corresponding attributes to the attribute server 82, and set the accumulative weights as zero after this reporting. The client 81 is further configured to send an advertisement playing request carrying the user identity to the advertisement server 83, receive the advertisement delivered by the advertisement server 83 and playing the advertisement.

The attribute server 82 is configured to determine the user according to the user identity received from the client 81, respectively accumulate the reported preset weights and accumulative weights of the user according to the attribute identities, determine the attribute corresponding to the weight of the maximal sum as the behavior attribute of the user and save the behavior attribute, or determine attributes corresponding to preset number of sums which are selected in a descending order as the behavior attributes of the user. The attribute server is further configured to receive a user attribute query request sent from the advertisement server 83, and return the behavior attribute information of the user to the advertisement server 83.

The advertisement server 83 is configured to receive the advertisement playing request from the client 81, send the user attribute query request carrying the user identity to the attribute server 82 according to the user identity carried in the advertisement playing request, receive the behavior attribute information of the corresponding user returned by the attribute server 82, match corresponding advertisements with the received behavior attribute information of the user, and deliver the advertisement which matches the behavior attribute information to the client 81 of the user.

It can be seen from the description of the above embodiments that the client processes the information sent from the user each time through presetting the matching words, the corresponding attribute of each matching word and the preset weight of each attribute in embodiments of the present invention, so that the probability of that the weights of the corresponding attributes of the matching words with a relatively high emergence frequency in the huge amount information sent from the user are accumulated increases adopting the accumulation mode, and thus the accumulative weights of the corresponding attributes increase. The corresponding attributes of the maximal accumulative weight are selected as the behavior attributes of the user. In the scheme of the present invention, since the matching word with a relatively high emergence frequency relates to things that interest the user most, the corresponding attributes (one or a plurality of attributes) of the matching word is closely related to one or a plurality of behavior attributes of the user, and the preset weights of the attributes represent the value of the relevance, it is accurate to determine the behavior attributes of the user according to the accumulative weights of the attributes.

After determining the relatively accurate behavior attributes of the user, various characteristic servers may be provided to the user. For instance, the advertisement may be delivered to the user according to the determined and relatively accurate behavior attributes of the user, which makes the pertinence of the advertisement more strong and effectively enhances the satisfaction of the user and the QoS of the network operator.

Apparently, those skilled in the art may make various modifications to the embodiments of the present invention without departing from the spirit or scope of the invention. Thus, if those modifications to the embodiments also belong to the scope of the claims and equal technology thereof, the present invention intends to include those modifications.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for determining behavior attributes of a user, comprising:
obtaining, by a client, transmission information from a user, matching the transmission information with preset matching words, and determining corresponding attributes of matching words which match the transmission information;
obtaining, by the client, a preset weight of each attribute in the corresponding attributes, and reporting a user identity of the user, the preset weights, and attribute identities of the corresponding attributes to an attribute server at the network side; or
accumulating, by the client, the preset weight of each attribute in the corresponding attributes, obtaining accumulative weights, and reporting the user identity of the user, the accumulative weights and the attribute identities of the corresponding attributes to the attribute server at the network side, and configuring the accumulative weights reported this time as zero after completing the reporting; and
respectively accumulating, by the attribute server, the reported preset weights or accumulative weights of the user corresponding to the user identity according to the attribute identities, obtaining a sum of each attribute corresponding to the user, determining an attribute corresponding to the maximal sum as the behavior attribute of the user and storing the behavior attribute, or determining attributes corresponding to preset number of sums which are selected in a descending order as behavior attributes of the user and storing the behavior attributes.

2. The method according to claim 1, wherein
the corresponding attributes of the matching words are determined by relevance of the matching words and one or multiple behavior attributes of the user; and
the preset weights of the corresponding attributes represent a value of the relevance.

3. The method according to claim 1, wherein reporting the user identity of the user, the accumulative weights, and the attribute identities of corresponding attributes to the attribute server at the network side comprises:
comparing the current accumulative weight of each attribute with a preset threshold;
reporting the user identity of the user, current accumulative weights, each of which is larger than the preset threshold, and attribute identities of attributes corresponding to the current accumulative weights to the attribute server at the network side.

4. The method according to claim 1, further comprising:
deleting, by the client, accumulative values and attribute identities of attributes corresponding to the accumulative values which are not updated in a preset time period.

5. The method according to claim 1, wherein
the matching words, the corresponding attribute identities of the matching words and the preset weight of each attribute are stored in the attribute server, and issued to the client for storing by the attribute server.

6. A system for determining behavior attributes of a user, comprising: a client and an attribute server; wherein
the client is configured to obtain transmission information of a user, match the transmission information with preset matching words, determine corresponding attributes of matching words which match the transmission information, obtain a preset weight of each attribute in the corresponding attributes, report a user identity of the user, the preset weights, and attribute identities of the corresponding attributes to the attribute server at the network side; or respectively accumulate the preset weight of each attribute in the corresponding attributes, obtain accumulative weights, and report the user identity of the user, the accumulative weights and the attribute identities of the corresponding attributes to the attribute server, and configure the accumulative weights reported this time as zero after completing the reporting; and
the attribute server is configured to respectively accumulate the reported preset weights or accumulative weights of the user corresponding to the user identity according to the attribute identities, obtain a sum of each attribute corresponding to the user, determine an attribute corresponding to the maximal sum as a behavior attribute of the user and store the behavior attribute; or determine attributes corresponding to preset number of sums which are selected in a descending order as behavior attributes of the user and store the behavior attributes.

7. The system according to claim 6, wherein
the corresponding attributes of the matching words are determined by relevance of the matching words and one or multiple behavior attributes of the user; and
the preset weights of the corresponding attributes represent the value of the relevance.

8. The system according to claim 7, wherein the client is further configured to compare current accumulative weight of each attribute which is stored in local with a preset threshold, and report the user identity of the user, current accumulative weights, each of which is larger than the preset threshold and attribute identities of attributes corresponding to the accumulative weights to the attribute server at the network side.

9. The system according to claim 8, wherein the attribute server is further configured to store information comprising the matching words, the corresponding attribute identities of the matching words and the preset weight of each attribute, and issue the information to the client; and
the client is further configured to receive the information comprising the matching words, the corresponding attribute identities of the matching words, and the preset weight of each attribute and store the information in local.

10. A method for delivering an advertisement, comprising:
receiving an advertisement playing request which is initiated by a client and carries a user identity;
obtaining behavior attribute information of a corresponding user according to the user identity from an attribute server at the network side;
matching advertisements with the behavior attribute information of the user, and sending a corresponding advertisement which matches the behavior attribute information to the client; wherein
the behavior attribute of the user is determined by:
obtaining, by a client, transmission information from the user, matching the transmission information with preset matching words, and determining corresponding attributes of matching words which match the transmission information;
obtaining, by the client, a preset weight of each attribute in the corresponding attributes, and reporting a user identity of the user, the preset weights, and attribute identities of the corresponding attributes to the attribute server at the network side; or
accumulating, by the client, the preset weight of each attribute in the corresponding attributes, obtaining accumulative weights, and reporting the user identity of the user, the accumulative weights and the attribute identities of the corresponding attributes to the attribute server at the network side, and configuring the accumulative weights which are reported this time and stored in local as zero after completing the reporting; and
respectively accumulating, by the attribute server, the reported preset weights or accumulative weights of the user corresponding to the user identity according to the attribute identities, obtaining a sum of each attribute corresponding to the user, determining an attribute corresponding to the maximal sum as the behavior attribute of the user and storing the behavior attribute, or determining attributes corresponding to preset number of sums which are selected in a descending order as behavior attributes and storing the behavior attributes.

11. The method according to claim 10, wherein
the corresponding attributes of the matching words are determined by relevance of the matching words and one or multiple behavior attributes of the user; and
the preset weights of the corresponding attributes represent the value of the relevance.

12. A system for delivering an advertisement, comprising a client, an attribute server and an advertisement server; wherein
the client is configured to obtain transmission information of a user, match the transmission information with preset matching words, determine corresponding attributes of matching words which match the transmission information, obtain a preset weight of each attribute in the corresponding attributes, report a user identity of the user, preset weights, and attribute identities of the corresponding attributes to the attribute server at the network side; or respectively accumulate the preset weight of each attribute in the corresponding attributes, obtain accumulative weights, report the user identity, the accumulative weights and the attribute identities of the corresponding attributes to the attribute server and configure the accumulative weights which are saved in local and reported this time as zero after completing the reporting; initiate an advertisement playing request carrying the user identity to the advertisement server, receive an advertisement delivered by the advertisement server and playing the advertisement;
the attribute server is configured to respectively accumulate reported preset weights or accumulative weights of the user corresponding to the user identity according to the attribute identities, obtain a sum of each attribute corresponding to the user, determining an attribute corresponding to the maximal sum as a behavior attribute of the user and store the behavior attribute, or determine attributes corresponding to preset number of sums which are selected in a descending order as behavior attributes of the user and store the behavior attributes, receive a user attribute query request sent from the advertisement server, and return the behavior attribute information of the corresponding user which is stored in local to the advertisement server; and
the advertisement server is configured to receive the advertisement playing request sent from the client, send the user attribute query request carrying the user identity to the attribute server according to the user identity carried in the advertisement playing request, receive the behavior attribute information of the corresponding user returned by the attribute server, match advertisements with the behavior attribute information of the user and deliver an advertisement which matches the behavior attribute information to the client.

13. The system according to claim 12, wherein the corresponding attributes of the matching words are determined by relevance of the matching words and one or multiple behavior attributes of the user; and
the preset weights of the corresponding attributes represent the value of the relevance.
